(19) United States
(12) Patent Application Publication
(10) Pub. No.: US 2026/0119988 A1
(43) Pub. Date: Apr. 30, 2026

(54) SYSTEM AND METHOD FOR AGRICULTURE MANAGEMENT

(71) Applicant: Tesseract Ventures, LLC, Overland Park, KS (US)

(72) Inventors: John Boucard, Tampa, FL (US); Chris Sartain, Leawood, KS (US); Jason Harrell, Tampa, FL (US)

(21) Appl. No.: 19/359,242

(22) Filed: Oct. 15, 2025

Related U.S. Application Data
(60) Provisional application No. 63/712,717, filed on Oct. 28, 2024.

(51) Int. Cl. G06N 20/00; G06F 9/451

(52) U.S. Cl. CPC G06N 20/00; G06F 9/451

(57) ABSTRACT

In at least one aspect, a computer-implemented method includes: accessing, by an agricultural management system, first data from an operational database; accessing, by the agricultural management system, second data from a real-time data server; determining a metric based on the first data and the second data; generating a first graphical user interface (GUI) for display on a client device, where the first GUI includes at least one data visualization based on the metric; and adjusting, by the agricultural management system, a setting of a piece of equipment.

### CROSS-REFERENCE TO RELATED APPLICATION

This application claims the benefit of U.S. Provisional Patent Application No. 63/712,717, filed in the U.S. Patent and Trademark Office on October 28, 2024, which is incorporated herein by reference in its entirety for all purposes.

### FIELD

The disclosure relates to systems and methods for agricultural management.

### BACKGROUND

As more data becomes available, organizations and enterprises aim to find ways to gather, store, and analyze the data to find efficiencies. However, the amount of available data can be cumbersome and inefficient to process. In certain industries, advances in equipment yield large amounts of data. Current systems struggle with efficiently handling and synthesizing these amounts of data, resulting in lost opportunities for discovering synergies and operational efficiencies.

### BRIEF DESCRIPTION OF THE DRAWINGS

To easily identify the discussion of any particular element or act, the most significant digit or digits in a reference number refer to the figure number in which that element is first introduced.

FIGS. 1A and 1B illustrate an example operating environment for providing an agricultural management system.

FIG. 2 illustrates a data ingestion process for an agricultural management system.

FIG. 3 illustrates another data ingestion process for an agricultural management system.

FIG. 4 illustrates another example operating environment for providing an agricultural management system.

FIG. 5 illustrates a method for automatically adjusting equipment.

FIGS. 6A, 6B, and 6C illustrate exemplary graphical user interfaces (GUIs) for displaying data visualizations generated by the agricultural management system.

FIG. 7 illustrates an example computing device for implementing an agricultural management system.

### DETAILED DESCRIPTION

Various examples of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an example in the present disclosure can be references to the same example or any example; and such references mean at least one of the examples.

Reference to “one example” or “an example” means that a particular feature, structure, or characteristic described in connection with the example is included in at least one example of the disclosure. The appearances of the phrase “in one example” in various places in the specification are not necessarily all referring to the same example, nor are separate or alternative examples mutually exclusive of other examples. Moreover, various features are described which may be exhibited by some examples and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various examples given in this specification.

Without intent to limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

This disclosure provides systems and methods for monitoring of an agricultural operation and dynamic and automated management of agricultural equipment.

As used herein, an agricultural operation can refer to any operation involving land and/or crop management. For example, an agricultural operation can be, for example, a farm. An agricultural operation may be associated with one or more plots or tracts of land that can be further divided into subdivisions. Each subdivision can be associated with a type of crop and/or livestock.

Equipment associated with the agricultural operation can be monitoring equipment such as one or more sensors or drones. For example, drones can be used to monitor plots or subdivisions using cameras, thermal imaging, air quality sensors, or other sensor devices to collect data on the current state of the plot. Sensors can also include, for example, soil sensors for measuring pH levels, one or more weather sensors for measuring weather conditions, irrigation sensors, and the like. Equipment can further include industrial farming equipment such as seeding equipment, planting equipment, harvesting equipment, irrigation equipment, and the like. In some examples, equipment includes a tracker, such as a GPS tracker or other location tracking device used for recording data associated with the location of the equipment.

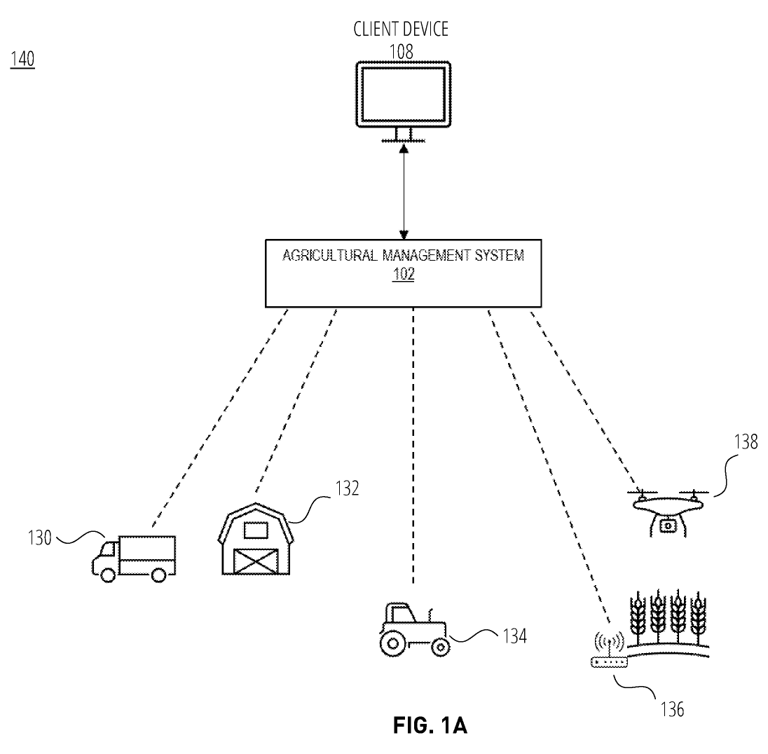

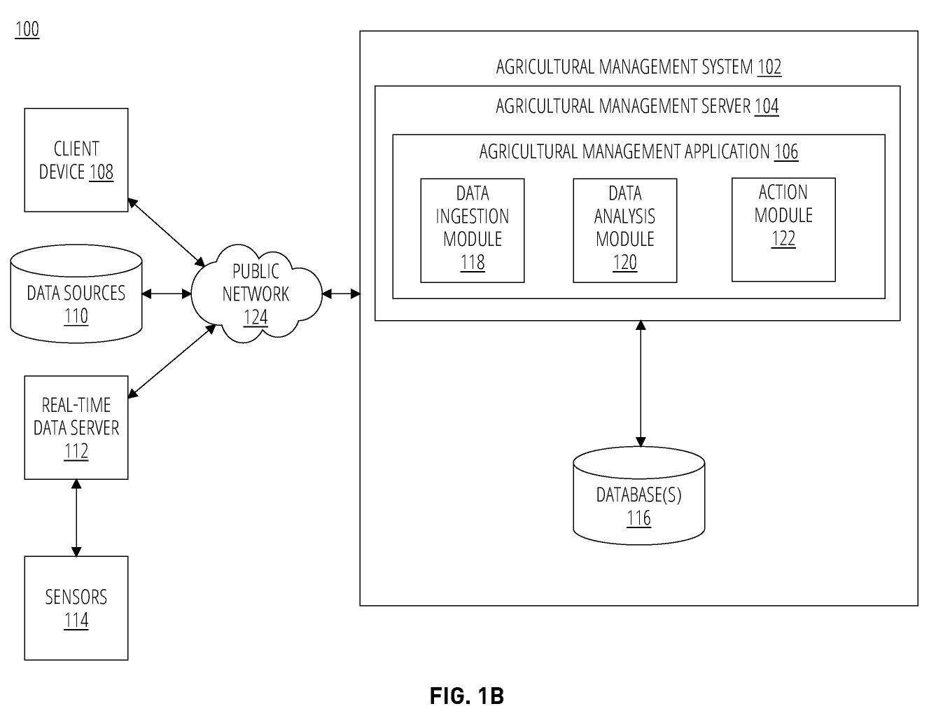

FIG. 1A illustrates an exemplary operating environment 140 for implementing an agricultural management system 102, which will be described in further detail with reference to FIG. 1B. The agricultural management system 102 can be implemented for monitoring and management of a farm or other agricultural operation. The agricultural operation can include, for example, trucks 130, buildings 132, farming equipment 134, sensors 136, and drones 138. Other equipment, machinery, or devices not pictured can also be included in the agricultural operation. The agricultural management system 102 can facilitate data analysis and data visualization by a user of the client device 108.

The components of the agricultural operation (e.g., trucks 130, buildings 132, farming equipment 134, sensors 136, and drones 138) can generate or collect data, which can be transmitted via one or more networks or mechanisms to the agricultural management system 102. The agricultural management system 102 can ingest and analyze the received data. In at least one example, the agricultural management system 102 can generate one or more metrics, such as statistics, trends, projections, and the like associated with the received data. The agricultural management system 102 can also analyze the data using one or more models to generate predictions of future metrics or to generate recommended actions to cause changes to the agricultural operation. In at least one example, the agricultural management system 102 can perform real-time monitoring of a subdivision of the agricultural operation. Based on the real-time monitoring, the agricultural management system 102 can determine that a particular metric has fallen below or above a predetermined threshold (for example, outside of a predetermined range) for the metric. The agricultural management system 102 can use one or more models to generate recommended actions that, when implemented, can cause the metric to return to or to approach the threshold value. In at least one example, the agricultural management system 102 can automatically (for example without user input or assistance) implement the recommended actions, e.g., by modifying a setting of a piece of farming equipment.

Trucks 130 can include any vehicles such as trucks or cars for transporting products of the agricultural operation. In at least one example, the trucks 130 can be equipped with sensors or trackers, which may include a GPS tracking device for tracking the locations of the trucks 130. In at least one example, the trucks 130 can carry products in packaging including sensors or devices (e.g., RFID tags, barcodes, NFC tags, and the like) for tracking logistics and inventory.

Buildings 132 can include one or more buildings of the agricultural operation. Buildings 132 can include barns, storage facilities and silos, equipment storage, office buildings, and the like. The buildings 132 can be smart buildings equipped with one or more sensors to collect access data (e.g., card swipes, building entry and exit, employee locations, etc.).

The equipment 134 can be equipped with sensors and/or trackers for tracking location or receiving data on the equipment operation (e.g., settings and configurations). The equipment 134 can include equipment or machinery such as tractors, harrows, balers, plows, augers, sprayers, seeders, and the like. In at least one example, the equipment 134 can include equipment for transportation on and around the agricultural operation such as all-terrain vehicles (ATVs).

The sensors 136 can include sensors configured to generate or collect agricultural data. For example, the sensors 136 can be placed in and around the agricultural operation. The sensors 136 can include temperature and humidity sensors, soil pH sensors, light sensors, soil moisture sensors, carbon dioxide sensors, and the like. The sensors 136 can be positioned in stationary locations or can be place on equipment or autonomous vehicles or robots. In at least one example, electrochemical sensors can be mounted on sleds or robots and can be used to gather and map soil chemical data. The sensors 136 can also include mechanical sensors for testing metrics like soil compaction. In at least one example, the sensors 136 can be used to predict equipment settings or requirements. The mechanical resistance of soil can, for example, be used to predict pulling requirements for tractors.

The drones 138 can include autonomous or manually controlled drones for monitoring the agricultural operation. The drones 138 can be mounted with sensors, trackers, or cameras and can collect data associated with the agricultural operation. For example, the drones 138 can collect camera images and/or thermal images of the agricultural operation. In at least one example, one or more drones can be programmed to monitor specific areas or subdivisions of the agricultural operation at predetermined intervals. The agricultural management system 102 can monitor the agricultural operation and in real-time re-assign or deploy one or more of the drones 138 to areas or subdivisions in which additional monitoring is needed (e.g., based on analysis of data by the agricultural management system 102). In some examples, the drones 138 can be operable to deploy materials such as chemicals, soil, water, etc. to adjust growth for the agricultural operation. In some examples, the drones 138 can be operable to relay communication and improve transmission signal, for example from the sensors 136 and/or the buildings 132.

The components (e.g., trucks 130, buildings 132, farming equipment 134, sensors 136, and drones 138) shown in FIG. 1A are not meant to be limiting and any other types of equipment, sensors, or devices can be included in the operating environment 140.

Disclosed systems and methods can include one or more pipelines for data ingestion. For example, the agricultural management system 102 can access data from one or more external databases and/or a real-time server, which may include data collected by trucks 130, buildings 132, farming equipment 134, sensors 136, and drones 138. The one or more external databases can be, for example, databases storing current and/or historical data associated with the agricultural operation. For example, when the agricultural operation is a part of a co-op, external databases can store shared co-op files including weather data, order data, imaging data, farmer data, employee data, operational data, and the like. The external databases can be physical or cloud databases. In some examples, co-op data can be stored in a blockchain and/or shared ledger. In some examples, an external cloud database can be accessed via one or more application programming interfaces (APIs). In some examples, the one or more external databases can include third-party databases (e.g., CASE, JD Ops, NOAA). Additional third-party data can include regulatory and/or sustainability data, which may include data associated with regulatory requirements, such as metrics or benchmarks. The agricultural data accessed from the various sensors, devices, and/or data sources can include weather data, satellite data, public source data, temperature data, video data, crop data, pest data, fertilizer data, livestock data, productivity data, equipment data, vehicle data, tractor data, and planter data, among others.

In some examples, the real-time server can collect and/or store sensor data. For example, the real-time server can receive data from a long-range wide area network (LoRaWAN) gateway, sensors, devices, or trackers. The real-time server can receive sensor data as a real-time data stream, and/or can received batched data. The agricultural management system 102 can access data from the real-time server via an API.

The agricultural management system 102 can ingest data from the above-described sources and can generate a graphical user interface (GUI) for displaying the data, and/or metrics and statistics determined from the data. For example, the agricultural management system 102 can generate data visualizations including interactive charts and graphs such as pie charts, bar graphs, histograms, and the like. The GUI can also display drone data including images or thermal imaging data of the agricultural operation. In some examples, the GUI can display data for a specified subdivision of the plot associated with the agricultural operation. The GUI can provide interactive data visualizations (e.g., via the client device 108) such that a user can view and explore comprehensive data associated with the operations and state of the agricultural operation. For example, the user can view drone images, weather data, soil data, irrigation data, harvest data, production data, employee data (e.g., scheduling, productivity, etc.), co-op data, seeding data, equipment data (e.g., equipment locations and settings), and/or the like.

In some examples, the agricultural management system 102 can apply the data from the external databases and/or the real-time server to one or more machine learning (ML) models. In some examples, the ML models can be trained on historical data associated with the agricultural operation and/or can output predictions of a future state of the agricultural operation based on a current and/or historical state of the agricultural operation. For example, an ML model can predict, based on sensor and weather data, an acidity level of soil in a subdivision of the plot at a future time. In some examples, the ML models can generate recommended operational changes for the agricultural operation. For example, one or more ML models can be configured to determine a set of steps needed to cause a change in a parameter associated with the subdivision of the plot.

Continuing the above example, a ML model can predict that the pH of the soil in a particular area of a subdivision of the plot of the agricultural operation will reach a certain level at a future time. The agricultural management system 102 can determine that this level varies from a predetermined threshold pH level for that subdivision. The agricultural management system 102 can use the ML model and/or another ML model to generate a set of steps for returning the pH level of the particular area to the threshold pH level for that subdivision. For example, the agricultural management system 102 can provide a recommendation that agricultural limestone be applied to the particular area. In some examples, the instructions can be transmitted to a computing device associated with a farmer or employee, such that the farmer or employee can act on the recommendation in real-time.

In some examples, the recommendations generated by the ML model can include instructions to change equipment settings. For example, if the agricultural management system 102 determines that a level of water retention of the soil in a subdivision of the plot is too high, the agricultural management system 102 can communicate with an irrigation system of the subdivision to cause the irrigation system to provide water to the subdivision less frequently, or to not provide water to the subdivision until the level of water retention reaches a threshold value. In some examples, the instructions to change equipment settings can be transmitted and enacted automatically without additional user input.

In some examples, the agricultural management system 102 can determine a current state of a subdivision requires monitoring. For example, the agricultural management system 102 can compare metrics associated with the subdivision (e.g., soil metrics, weed density, crop growth, etc.) to predetermined thresholds associated with each metric. Based on the determination of deviation from one or more thresholds, or on a prediction of future deviation from one or more thresholds, the agricultural management system 102 can, for example, increase a sensor sampling rate or deploy additional sensing equipment or drones to monitor the subdivision.

In some examples, a front-end can provide one or more graphical user interfaces (GUIs) for enabling a user to interact, via a client device, with the agricultural management system 102. The one or more GUIs can also provide interactive visualizations of current, historic, and predicted future agricultural data associated with the agricultural operation. In some examples, the one or more GUIs can provide metrics and visualizations associated with metrics calculated using the agricultural data. For example, a GUI can provide sustainability information such as field- and/or subdivision-level sustainability attributes and a carbon intensity (CI) score. The agricultural management system 102 can use machine learning or trend analysis to predict future attribute values and a future CI score and provide recommended steps for improving or maintaining the CI score. In some examples, for each subdivision or field, the one or more GUIs can provide maps including overlaid data visualizations to show geolocated data. Thus, a user can view field events across a farm or agricultural operation via a client device 108. In at least one example, a GUI can include manipulatable and interactive maps and visualizations, to enable a user to compare, sort, and understand aggregated data. In some examples, the maps and/or visualizations can be two-dimensional. In some examples, the maps and/or visualizations can be three-dimensional. In some examples, a GUI can facilitate side-by-side comparison of current data and historic data or of data from two or more different time periods or locations.

In addition to data visualization, one or more GUIs can provide real-time metrics for monitoring by a user and can allow a user to compare and visualize agricultural data. For example, a GUI can display real-time field nutrient and moisture readings determined by one or more sensors. In some examples, the agricultural management system 102 can independently monitor field metrics. For example, the agricultural management system 102 can, in real-time, determine, based on sensor data, that one or more metrics has deviated from a threshold or an accepted range. Based on the deviation, the agricultural management system 102 can provide an alert to a user via a client device and/or can automatically take an action to cause the metric to return to the threshold value or to return within the accepted range. In some examples, an action can include increasing a sampling rate of one or more sensors when a deviation is detected to gather additional data regarding the metric.

Accordingly, the agricultural management system 102 can be used to reduce cost associated with managing an agricultural operation by monitoring plot metrics, by automatically adjusting equipment settings and/or providing recommendations to optimize the agricultural operation. The agricultural management system 102 can leverage data ingestion techniques to receive and standardize data from a number of sources, such that the data can be used to train one or more ML models to predict future metrics of the agricultural operation. Further, the one or more ML models can automatically adjust equipment settings based on real-time data and/or future predictions to optimize operations.

Disclosed systems and methods facilitate ingestion, analysis, and visualization of agricultural data and provide the infrastructure for supporting a comprehensive platform for agricultural data analysis and visualization, and agricultural operation monitoring and management. For example, the disclosed systems and methods provide techniques for data ingestion that allow for hands-off data transfer following an initial connection process and setup.

FIG. 1B is a diagram of an example of an operating environment 100 in which an agricultural management system 102 can monitor an agricultural operation and/or adjust equipment associated with the agricultural operation. The operating environment 100 can include one or more components of the operating environment 140, discussed with reference to FIG. 1A.

FIG. 1B illustrates an example of hardware components of an agricultural management system 102, which may be distributed across one or more computing devices. In some aspects, the agricultural management system 102 can be a specialized computing system that may be used for processing large amounts of data, possibly using a large number of computer processing cycles. The agricultural management system 102 can include an agricultural management server 104 for performing monitoring of the agricultural operation and adjustment of equipment as described herein.

The agricultural management server 104 can include one or more processing devices that execute program code, such as an agricultural management application 106. The program code is stored on a non-transitory computer-readable medium. The agricultural management application 106 can execute one or more processes to ingest data, analyze data, and use one or more trained machine learning models to automatically manage equipment settings for equipment associated with an agricultural operation.

In some aspects, the agricultural management application 106 can ingest and synthesize data from one or more data sources 110. For example, the data sources 110 can include shared or uploaded data files or data accessed from external systems via one or more application programming interfaces (APIs). In some examples, the agricultural management system 102 can also receive data form a real-time data server 112. Data received from the real-time data server 112 can include data collected and/or generated by sensors 114. The agricultural management application 106 can ingest and standardize the received data and store the data in the database(s) 116. The data stored in the database(s) 116 can be analyzed by the agricultural management application 106 and presented to a user via an interface of the client device 108. The analysis of the data can be used to generate insights and recommendations for managing the agricultural operation. The agricultural management application 106 can also train a machine learning model using data from the database(s) 116 to predict a future state of the agricultural operation and to recommend actions (e.g., changes in equipment settings) for managing the state of the agricultural operation. In some examples, the agricultural management application 106 can communicate with the equipment to automatically and dynamically modify one or more settings to affect the operation of the equipment in real-time.

Network-attached storage units, such as the database(s) 116, may store a variety of different types of data organized in a variety of different ways and from a variety of different sources (e.g., from the data sources 110 or the real-time data server 112). For example, the network-attached storage unit may include storage other than primary storage located within the agricultural management server 104 that is directly accessible by processors located therein. In some aspects, the network-attached storage unit may include secondary, tertiary, or auxiliary storage, such as large hard drives, servers, virtual memory, or other types. Storage devices may include portable or non-portable storage devices, optical storage devices, or various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory or memory devices.

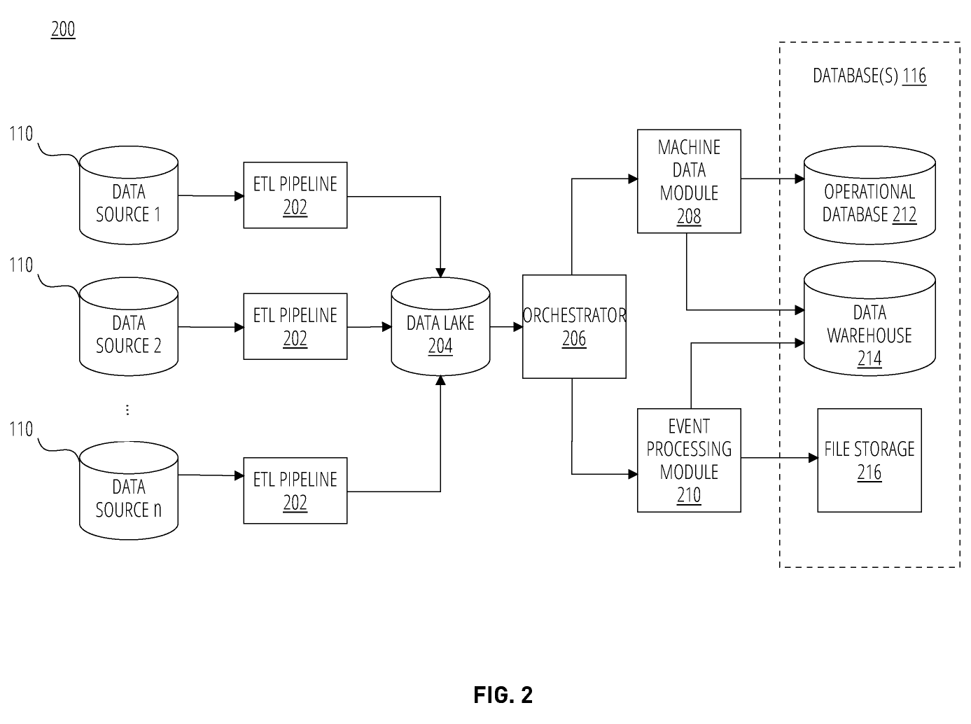

In some examples, the database(s) 116 can store agricultural data associated with a particular time period (e.g., a current season, a current fiscal year, a current calendar year, etc.). In such an example, a cloud-based data warehouse (not shown) can store historical data that was recorded in a previous time period. The database(s) 116 will be described in further detail with respect to FIG. 2, below.

The agricultural management server 104 can include one or more processing devices that execute program code, such as the agricultural management application 106. The program code is stored on a non-transitory computer-readable medium. The agricultural management application 106 can execute one or more processes to synthesize and analyze data, generate and/or display insights based on the data, and/or adjust equipment settings based on the data. For example, the agricultural management application 106 can include a data ingestion module 118, and data analysis module 120, and an action module 122.

The agricultural management system 102 can communicate with various other computing systems, such as the client device 108. For example, the client device 108 may interact with the agricultural management system 102 via one or more public networks 124 to facilitate interactions between users of the client device 108 and interactive computing environments provided by the agricultural management system 102. Additionally, the agricultural management system 102 can interact with the data sources 110 and the real-time data server 112 via the public network 124 to receive data, as well as to communicate with remote equipment via the real-time data server 112.

Each client device 108 may include one or more third-party devices, such as individual servers or groups of servers operating in a distributed manner. A client device 108 can include any computing device or group of computing devices operated by a farm operator, government agent, agricultural worked, and/or other provider of agricultural and/or land-related products and/or services. The client device 108 can include one or more server devices.

The agricultural management system 102 can further include one or more processing devices that are capable of providing the interactive computing environment to perform operations described herein. The interactive computing environment can include executable instructions stored in one or more non-transitory computer-readable media. The instructions providing the interactive computing environment can configure one or more processing devices to perform operations described herein. In some examples, the executable instructions for the interactive computing environment can include instructions that provide one or more graphical interfaces. The graphical interfaces are used by the client device 108 to access various functions of the interactive computing environment. For instance, the interactive computing environment may transmit data to and receive data from the client device 108 to view data visualizations or to cause changes to the settings of equipment.

In some examples, the agricultural management system 102 may have other computing resources associated therewith (not shown in FIG. 1), such as server computers hosting and managing virtual machine instances for providing cloud computing services, server computers hosting and managing online storage resources for users, server computers for providing database services, and others. The interaction between the agricultural management system 102 and the client device 108 may be performed through graphical user interfaces (GUIs) presented by the client device 108 to a user, or through an application programming interface (API) calls or web service calls.

For instance, the user can use the client device 108 to interact with the agricultural management system 102 via one or more GUIs. For example, the user, via the client device 108 can request data or data visualizations for data stored in the database(s) 116. For example, the user can provide parameters such as a location, time period, certain statistics, and the like, that they wish to view. The agricultural management system 102 can query the database(s) 116 using the specified parameters to retrieve relevant data. The agricultural management system 102 can also analyze the retrieved data to provide summaries, insights, metrics, and/or statistics associated with the data. In some examples, the agricultural management system 102 can apply the data to a machine learning model trained to output a projected future state of the location. In some examples, the machine learning model can be trained to determine whether a set of statistics associated with the location meet a set of predetermined thresholds. When the set of statistics do not meet the predetermined thresholds, the machine learning model can output recommended changes to equipment settings to help the location in meeting the thresholds. In some examples, the machine learning model can recommend one or more actions to be taken by farm workers.

Each communication within the operating environment 100 may occur over one or more data networks, such as a public network 124. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The numbers of devices depicted in FIG. 1B are provided for illustrative purposes. Different numbers of devices may be used. For example, while certain devices or systems are shown as single devices in FIG. 1B, multiple devices may instead be used to implement these devices or systems. Analogously, devices or systems that are shown as separate may be instead implemented in a single device or system.

FIG. 2 is an illustration of an exemplary data ingestion process 200. The data ingestion process 200 can be executed by one or more components of the operating environment 100. For example, the process 200 can be executed, in part, by the data ingestion module 118 of the agricultural management system 102. In some examples, the data ingestion process 200 can be a microservice-based process executing in a cloud environment.

In data ingestion process 200, data can be accessed from a number of data sources 110. For example, each data source 110 can be associated with an ETL pipeline 202. Each ETL pipeline 202 can be, for example, an event-driven pipeline configured to receive or access raw data from the data sources 110 control the processing and storage of the raw data. As discussed above, the data sources 110 can include databases containing co-op data, employee or farmer files, order information, imaging data, weather data, etc. The data stored in the data sources 110 can include both current data (e.g., current fiscal year, current fiscal quarter, current season, etc.) and/or historical data.

The ETL pipeline 202 can be configured to generate an event stored in the data lake 204 when data is received from each of the data sources 110. Each event can include metadata such as an event type or an indication of the originating data source. The event type can be used to determine what type of data processing the raw data needs to undergo to be cleaned and standardized.

In some examples, the raw data can be processed and cleaned. For example, one or more ML models can be used to clean and standardize the raw data. In at least one example, unstructured data can be transformed into structured data of a predetermined and standardized format. In some examples, the raw data can be enriched using data from additional data sources.

Once the raw data is cleaned and processed, the raw data and its associated event can be pushed to orchestrator 206. Orchestrator 206 can include an orchestrator handling one or more event queues, such that each event is routed to an event queue based on its event type. For example, if machine data (e.g., machine data received via API from a third-party platform) is ingested, the orchestrator 206 may route the machine data (e.g., based on the event type associating the data to machine data) to a machine data module 208. The machine data module 208 can include one or more microservices or serverless functions for formatting and standardizing data. For example, particular fields, such as date fields, can be converted to a standard format. In some examples, certain fields can be merged or separated. In some examples, the machine data module 208 can include a compiler that triggers a cloud-based processing function for converting machine data from a data source 110 to a common format. The formatted data can then be stored in the operational database 212. As discussed above, in some examples, historical data (e.g., data collected prior to a current season or time period) can be stored in a data warehouse 214.

In some examples, based on the event type, the orchestrator 206 can route the received data to an event processing module 210. In some examples, the event processing module 210 can include one or more microservices for processing data associated with one or more event types. In some examples, the event processing module 210 can, for example, receive agricultural data associated with certain event types and can generate one or more files to be used to generate one or more GUIs for data visualization (e.g., GeoJSON files). These generated files can be stored in the file storage 216 and can be accessible via an API such that the files can be used to generate geographically accurate visualizations of the agricultural operation or its subdivisions.

Accordingly, after the data ingestion process 200, the data stored in database(s) 116 can be accessible to a user via a client device (e.g., the client device 108). The data stored in the database(s) 116 can also be used as training data to train one or more ML models for generating predictions or recommended actions based on agricultural data. Thus, after initial set up (e.g., set up of the data sources 110), the data ingestion process 200 can execute automatically and independently. For example, data can be ingested in real-time as changes occur to data stored in the data sources 110, and/or data can be ingested periodically at predetermined intervals.

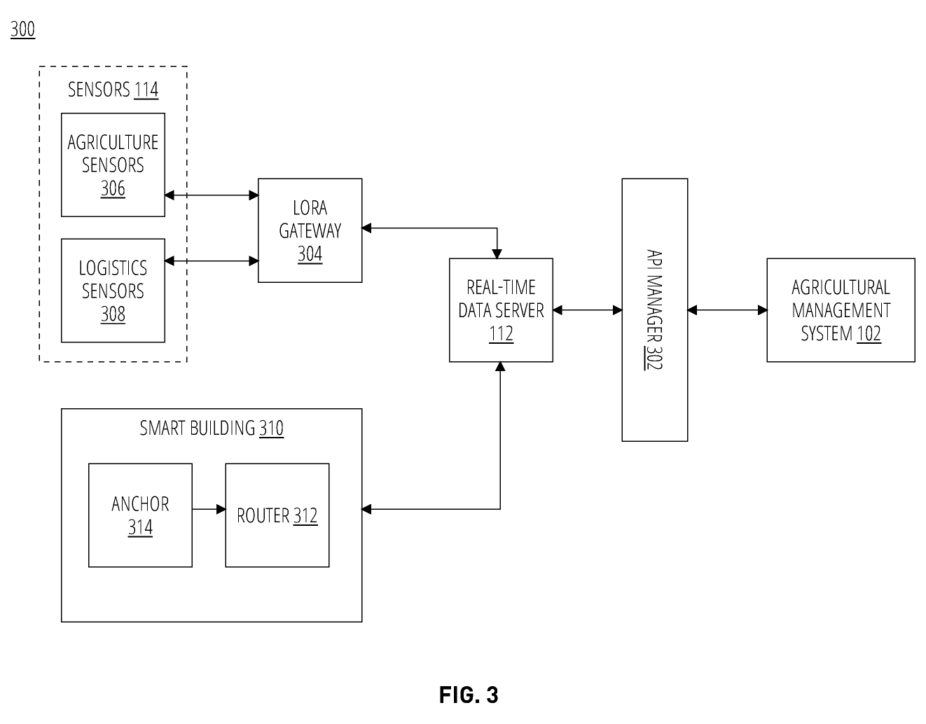

FIG. 3 is an illustration of another exemplary data ingestion process 300. The data ingestion process 300 can be executed by one or more components of the operating environment 100. For example, the data ingestion process 300 can be executed, in part, by the data ingestion module 118 of the agricultural management system 102. In some examples, the data ingestion process 300 can be a microservice-based process executing in a cloud environment.

As discussed above, real-time data server 112 can access data collected by one or more sensors. Those sensors can be agriculture sensors 306 or logistics sensors 308. Exemplary agriculture sensors 306 can include soil sensors, weather sensors, crop monitoring sensors and/or equipment, and/or other sensors configured to receive data associated with managing an agricultural operation. Logistics sensors 308 can include, for example, sensors configured to receive data associated with agricultural operation logistics, such as packaging, shipping, order management, and the like. Logistics sensors 308 can include RFID readers, barcode scanners, trackers, and/or other sensors configured to collect data associated with order tracking and fulfillment and shipping.

The sensors 114 (e.g., the agriculture sensors 306 and/or the logistics sensors 308) can be connected to a low-power, wide-area network protocol designed to wirelessly connect battery-operated devices to the internet in regional, national, and/or global networks. For example, the sensors 114 can be connected to a LoRa gateway 304 via a Long Range Wide Area Network (LoRaWAN). LoRaWAN can include end devices such as nodes using LoRa radio modulation and gateway, which can act as bridges between end devices and the network server. The gateway 304 can receive LoRa signals and/or packets from end devices and forward them to the network server via standard IP connections (e.g., Ethernet and/or cellular networks). The range of LoRa networks can vary based on obstructions, weather conditions, and terrain can be up to 20 kilometers. The nodes are the sensors 114 or actuators that collect data and/or perform actions. Examples of sensors 114 can include temperature sensors, smart meters, GPS trackers, and/or environmental sensors. In some examples, the sensors 114 can transmit data to the real-time data server 112 via the LoRa gateway 304. In some examples, the data can be streamed in real-time to the real-time data server 112. In another example, data can be collected at each respective sensor and transmitted via a batching process to the real-time data server 112. In at least one example, the real-time data server 112 can process received LoRa packets via either an Internet-of-Things (IoT) edge server on a secure local server or a publicly hosted open source IoT LoRa controller.

In some examples, the data ingestion process 300 can include receiving smart building data from a smart building 310. The smart building 310 can be a building associated with the agricultural operation (e.g., a storage building, processing building, equipment storage building, etc.). In some examples, the smart building 310 can include one or more anchors 314. An anchor 314 can include, for example, a sensor at an access point of the smart building 310 such that an employee can scan a badge at the sensor for access to the smart building 310. Thus, the one or more anchors 314 can provide insight into employee access and activity. Anchors 314 can, in some examples, be included on equipment or particular rooms within a smart building 310. The one or more anchors 314 can be associated with a router 312, which is configured to communicate with the real-time data server 112 via a network (e.g., the public network 124).

As discussed above, the real-time data server 112 can receive raw data from the sensors 114 and the smart building 310. The real-time data server 112 can then transmit the data, either in real-time or in batches, to the agricultural management system 102. In some examples, the real-time data server 112 can interface with the agricultural management system 102 via an API manager 302. The API manager 302 can manage one or more APIs through which the real-time data server 112 can provide data to the agricultural management system 102 for handling via a data ingestion process managed or executed by the data ingestion module 118. For example, the API manager 302 can translate and map external public facing endpoints, thereby managing public access to the API platform. The API manager 302 can also link public or government networks to secure on-premises networks.

In some examples, the data from the real-time data server 112 can be received at the agricultural management system 102 and/or proceed for further processing through the data ingestion process 200, described with reference to FIG. 2. For example, data from the real-time data server 112 can be ingested via the data lake 204 and be routed by the orchestrator 206 to an appropriate module for processing. The real-time data can eventually be stored in database(s) 116.

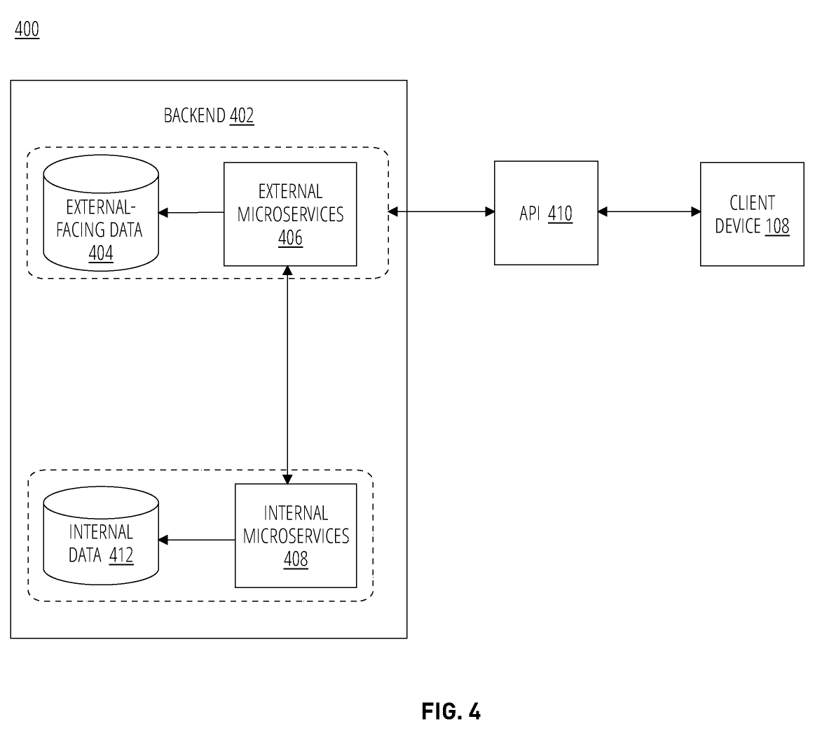

FIG. 4 is an illustration of another exemplary operating environment 400 for monitoring and automatically managing an agricultural operation. In addition to the components illustrated in FIG. 4, the operating environment 400 can also be implemented using any combination of components illustrated in operating environment 100 described with reference to FIG. 1.

A client device 108 can be used by a user (e.g., a farmer, government agent, agricultural operation employee, etc.) to interact with the agricultural management system 102. For example, the client device 108 can interact with a backend 402 of the agricultural management system 102 via an API 410. The API 410 can be called via a web browser, application, and/or other interface of the client device 108. The API 410 can, in some examples, include one or more APIs configured to provide access to different functionality or data of the agricultural management system 102. API 410 can include an API for querying raw real-time data received from the real-time data server 112 and stored by the agricultural management system 102. In some examples, the API 410 can be configured to receive parameters such as a time period and subdivision and provide a GUI displaying one or more visualizations of the agricultural data associated with that time period for that subdivision.

In some examples, the API 410 can be a collection of APIs (or an API manager managing a collection of APIs) including APIs for user onboarding and authentication, field visualizations (e.g., tillage/fertilizer/harvest information, furrow/sidress/pre-pesticide information, seed analysis/elevation/time period information), sustainability applications (e.g., for visibility into sustainability metrics), weed pressure/emergence information, and financial and product information. The various APIs in the collection can interface with different back-end microservices, which analyze data from the database(s) 116 and provide data visualizations for exploring historical data and for monitoring agricultural operation conditions in real-time.

The operating environment 400 can provide data security by only enabling direct interaction between the external microservices 406 and the client device 108, while facilitating indirect interaction between the client device 108 and the internal microservices 408. In some examples, security is further increased by obscuring the endpoints between the external microservices 406 and the internal microservices 408 via an endpoint routing component or program. Thus, via API 410 the user of the client device 108 can access the underlying back-end functionality of the agricultural management system 102 to retrieve data and visualizations from the external-facing data 404.

In some examples, access to the internal microservices 408 (e.g., microservices handling the internal data 412 or administrative functions of the agricultural management system 102), can be limited to particular users or particular user account types. An authentication service of the backend 402 can be used to authenticate a user of the client device 108 to enable interaction with the internal microservices 408 and internal data 412. Although shown separately in FIG. 4, the external-facing data 404 and internal data 412 can be stored in a single database (e.g., with different privileges associated with each type of data).

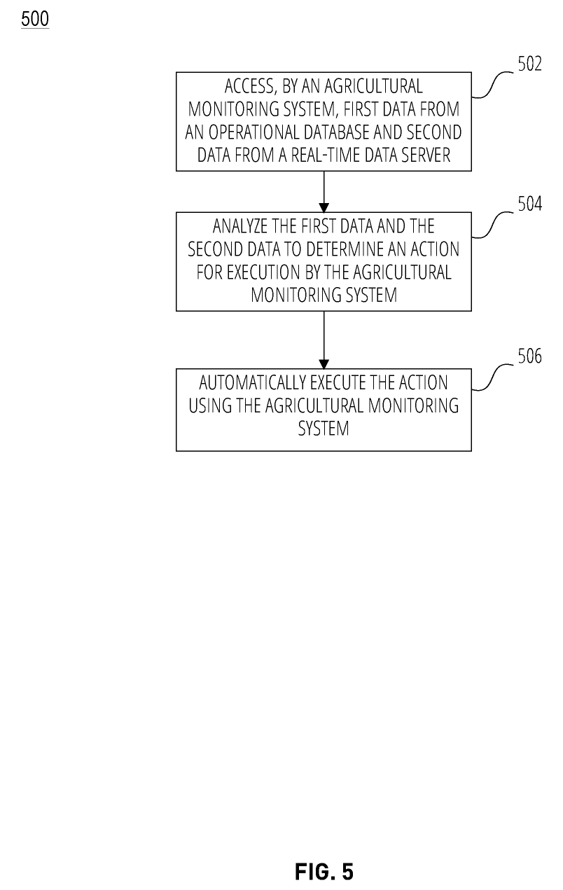

FIG. 5 illustrates a method 500 for automatically executing an action using an agricultural management system based on data received from multiple data sources. The method 500 can be executed using one or more components of an agricultural management system 102 as described in FIGS. 1A and 1B.

At block 502, the method 500 can include accessing, by the agricultural management system 102, first data from the database(s) 116 and/or second data from the real-time data server 112. The first data and the second data can include data associated with an agricultural operation. As discussed above, the first data from the database(s) 116 can include data that has been ingested (e.g., using the process 200 described with reference to FIG. 2) and can include data from one or more data sources 110. The first data can include regulatory information, historic and current weather data, financial and operations information, co-op data, employee and farmer data, and the like. The second data can be received from the real-time data server 112 (e.g., using the process 300 described with reference to FIG. 3). The second data can include sensor data from any combination of the sensors 114 (e.g., the agriculture sensors 306 and the logistics sensors 308) and the smart building 310. For example, the second data can include product supply information, order information, shipping information, logistics information (e.g., delivery truck location information), and the like.

At block 504, the method 500 can include analyzing, by the agricultural management system 102, the first data and the second data to determine an action for execution by the agricultural management system 102. Analyzing the first data and the second data to determine an action can include, in part, determining a metric based on the first data and the second data and generating a first graphical user interface (GUI) for display on a client device, where the first GUI includes at least one data visualization based on the metric. In some examples, the metric can be used as a basis or input for determining the action.

For example, the data analysis module 120 of the agricultural management system 102 can access data from the database(s) 116 and the real-time data server 112 and apply one or more analysis techniques (e.g., data analysis, data processing, statistical analysis, and the like). The data analysis module 120 can, for example, determine metrics and statistics associated with the agricultural operation. The metrics and statistics can be associated with the plot of the agricultural operation or one or more subdivisions of the plot. Metrics can include, for example, weed density in an area, crop density in an area, average crop height, most recent pesticide treatment of an area, soil pH of an area, soil composition of an area, and the like. Statistics can include, for example, average rainfall during the current season, historic average crop yield of a particular season, average yield of a particular subdivision compared with the average yield of other subdivisions growing the same crop, and the like.

In some examples, the data analysis module 120 can generate real-time visualizations of sensor or device data. As an example, one or more drones may collect real-time imaging data of a subdivision of the agricultural operation that can be used to determine weed pressure. The data analysis module 120 can use one or more image analysis techniques or machine learning to determine, from the imaging data, the weed pressure for the subdivision. This information can be displayed via an interface of the client device 108. In some examples, a GUI can display a side-by-side comparison of the current weed pressure with a historic weed pressure from a previous period of time.

In some examples, the analysis by the data analysis module 120 can include data processing and analysis and, in some examples can include training a ML model, on a corpus of agricultural data (e.g., from the data sources 110, database(s) 116, the real-time data server 112, and any third-party (e.g., government, scientific, industry) databases. The ML model can be trained to predict a future state of the agricultural operation or of one or more subdivisions of the agricultural operation. For example, the ML model can be trained to predict a future value of a particular metric or statistic, or a set of metrics or statistics, at a particular time (e.g., at a specified future time or over a specified time period). Thus the ML model can be trained to predict, for example, a crop yield based on current and historic conditions, a water retention amount for soil in a particular subdivision, a pH level of soil after the current season, etc.

In some examples, a ML model can also be trained (e.g., using action module 122) to predict an action for optimizing one or more metrics of the agricultural operation or of a subdivision of the agricultural operation. For example, an action can include a change to the settings or operation of one or more pieces of equipment of the agricultural operation. In some examples, an action can also be a change in staffing or employee responsibilities or schedule.

In some examples, the ML model can be trained to predict an area or subdivision of the agricultural operation identified for enhanced or additional monitoring. For example, the agricultural management system 102 can store one or more predetermined ranges or thresholds associated with different metrics. If a current value of a subset of metrics for a particular subdivision varies from the threshold value, or is outside a range of values, the ML agricultural management system 102 can generate instructions for causing equipment or sensors to monitor the subdivision. For example, the agricultural management system 102 can cause equipment, such as a drone, to deploy to the subdivision to collect additional data, or the agricultural management system 102 can cause the sampling rate of a sensor in the subdivision to increase. In some examples, the equipment, such as one or more drones, can be deployed to address the issue, for example spraying one or more chemicals to a specific zone of the plot of land. This can save the time and/or effort of a person trying to access that part of the plot of land.

Returning to FIG. 5, at block 506, the method 500 can include automatically executing, by the agricultural management system 102, the action determined at block 504. The action can include, for example, adjusting a setting of a piece of equipment associated with the agricultural operation. For example, if the action involves increasing a sensor sampling rate, the agricultural management system 102 can communicate via the LoRa gateway 304 with a subset of the sensors 114 to modify the sensor settings, thereby increasing the sampling rate. In some examples, the agricultural management system 102 can communicate instructions to a drone docking station for upload to one or more drones when the drones are docked. In some examples, the action can be broken down into one or more incremental steps, such that changes to equipment settings are applied incrementally until the action is complete.

In some examples, the action can be provided to a user via a GUI. For example, a ML model of the action module 122 can determine a recommended action to optimize one or more metrics associated with a particular subdivision of the agricultural operation. The recommended action and/or the predicted outcome of the action can be displayed to the user via the GUI. In some examples, the user can be presented with a set of actions and can select which actions to implement. Upon receiving confirmation of the action or actions via the GUI, the agricultural management system 102 can communicate with the relevant equipment or sensors to execute the action.

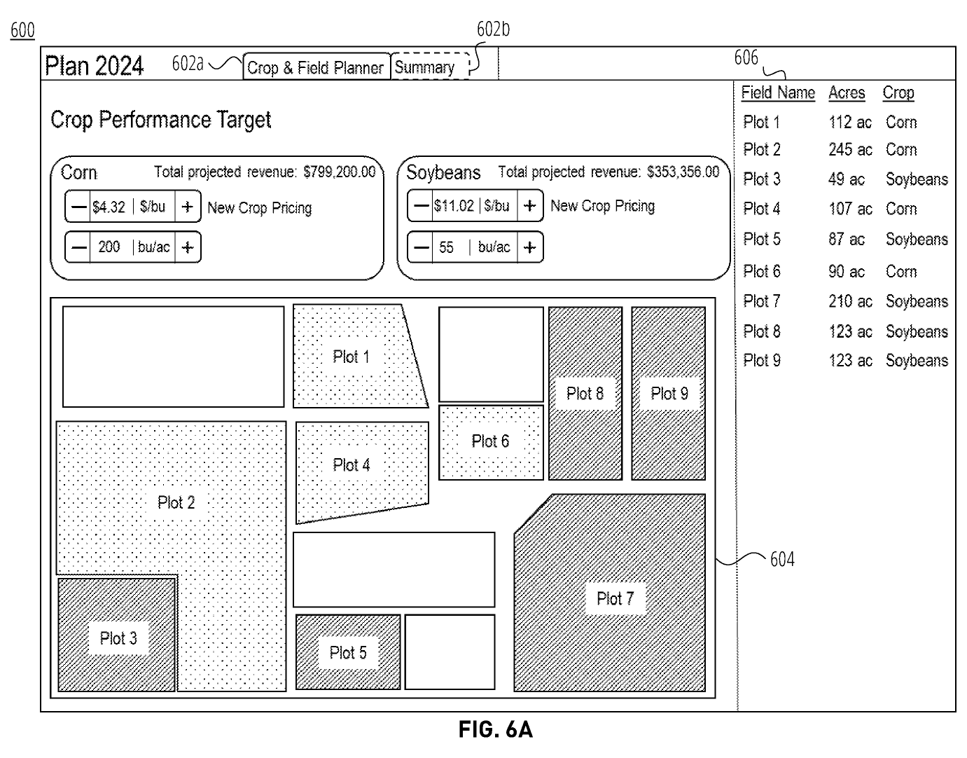

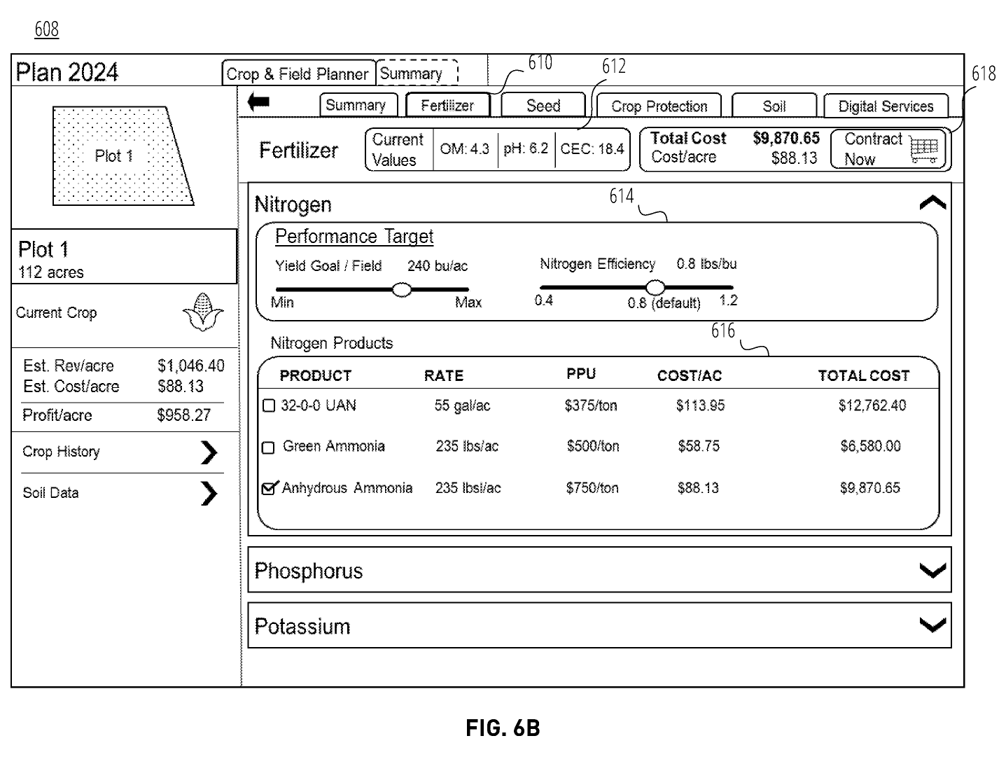

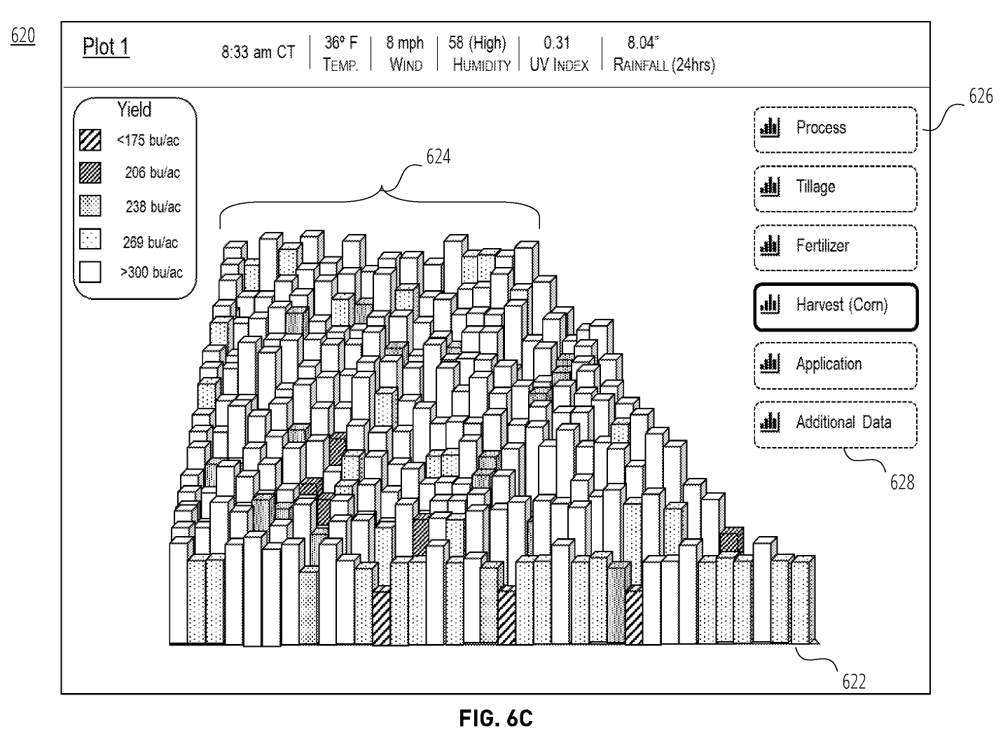

FIGS. 6A, 6B, and 6C illustrate exemplary GUIs (e.g., GUIs 600, 608, and 620) that can be generated by the agricultural management system 102 and provided to a user via an output device or interface of the client device 108.

As illustrated in FIG. 6A, GUI 600 can facilitate exploration and visualization of agricultural data captured and analyzed by the agricultural management system 102. The GUI 600 can display agricultural data associated with a particular year, time period, or season. The GUI 600 can include one or more tabs (e.g., a crop and field planner tab 602a and a summary tab 602b). As shown in FIG. 6A, the crop and field planner tab 602a can display a labeled map 604 of one or more plots (e.g., subdivisions) of the agricultural operation. In at least one example, the map can be a satellite image or drone-captured images of the agricultural operation with an overlay outlining the plots. In some aspects, the overlay can be color-coded or otherwise labeled to indicate which crops are planted in or planned to be planted in each plot. The GUI 600 can further display crop prices that are updated in real-time. For example, these prices can be scraped from a website by the agricultural management system 102 or can be retrieved from an external system via an API.

In at least one example, the GUI 600 can include a panel 606 displaying information associated with each plot (e.g., the plot name or field name, plot acreage, and which crop is planted in the plot). The plot name can, in some cases, be selectable such that the agricultural management system 102 generates a GUI 608, shown in FIG. 6B, for viewing and interacting with data associated with the selected plot.

The interface illustrated in FIG. 6B can provide information associated with a selected plot or subdivision of the agricultural operation, e.g., Plot 1. The GUI 608 can include a number of selectable sub-tabs (e.g., fertilizer sub-tab 610). When a particular sub-tab is selected, the GUI 608 can display information and data collected by trucks 130, buildings 132, equipment 134, sensors 136, and drones 138, as well as from data sources 110 associated with the topic of the sub-tab.

By way of non-limiting example, a user can select the fertilizer sub-tab 610 to view metrics and information associated with fertilization of the soil of Plot 1. The GUI 608 can display a panel 612 with current values of soil metrics (e.g., water level, organic matter (OM) content, pH level, and cation exchange capacity (CEC)). The values displayed in panel 612 can be received from soil sensors located in Plot 1. In some examples, the current values can update in real-time as sensor data is received by the agricultural management system 102.

The GUI 608 can further display information associated with various elements of soil composition (e.g., nitrogen, phosphorus, potassium, and the like). In this example, the GUI 608 can include adjustable performance targets 614 for metrics related to the nitrogen content of the soil in Plot 1. Performance targets can include, for example, a crop yield goal and a nitrogen efficiency. Performance targets can be selected by the user via slider bar, input field, dropdown menu, and the like. In at least one example, the performance targets can be monitored by the agricultural management system 102 such that the agricultural management system 102 can determine one or more actions for reaching the performance targets.

In some examples, the GUI 608 can display a list 616 of available products used for reaching the performance targets (e.g., that can be used to affect the nitrogen efficiency and yield of Plot 1. The list 616 can include product names, rates per acre, cost per acre, and a total estimated cost for the plot. In some aspects, the list 616 can include additional information for each product including a brand name, vendor, application method, and the like. For a selected product, the GUI 608 can display an estimated total cost to purchase the product for the plot and can include a button 618 for completing a purchase of the product from a third-party vendor. In at least one example, the agricultural management system 102 can be used to complete a purchase or transaction with a third-party vendor system. In some examples, the agricultural management system 102 can, e.g., using an ML model, generate recommendations or suggestions of products or services for purchase via the GUI 608 for meeting the performance targets.

The GUI 608 can further display additional metrics associated with Plot 1 such as an estimated revenue per acre, estimated cost per acre, and estimated profit per acre. These estimations can be determined by the agricultural management system 102 based on data receive via one or more sensors or devices and data ingested from one or more databases. The GUI 608 can dynamically update the estimations and other metrics based on real-time data updates.

As shown in FIG. 6C, GUI 620 is another exemplary interface for viewing data associated with a field or subdivision (e.g., Plot 1) of the agricultural operation. The GUI 620 can include a depiction 622 of Plot 1 (e.g., an outline, map, satellite image, drone image, and the like). The depiction 622 can be overlaid with data gathered and analyzed by the agricultural monitoring system 102. In the non-limiting example shown in FIG. 6C, the GUI 620 can include the depiction 622 of Plot 1 overlaid with bars 624 representing the yield per unit area of Plot 1. The bars can be sized, shaded, color-coded, and/or otherwise distinguished to represent various amounts of yield. For example, greater yield may be reflected with a larger bar in green, while lesser yield below a predetermined threshold may be reflected with a smaller bar in red.

The GUI 622 can further enable a user to view additional metrics overlaid on the depiction 622 of Plot 1. For example, the user can select from a list 626 of available topics, e.g., “Process,” “Tillage,” “Fertilizer,” or “Application,” to view associated metrics per unit area of Plot 1. In some examples, the user can view additional data by selecting an “Additional Data” button 628, which can open a menu or pop-up window displaying a set of additional selectable topics. These topics can include, for example, cost, profit, pesticide, or other agricultural or financial topics.

In some examples, each bar of the bars 624 may be selectable such that a user can view additional data related to the area of Plot 1 represented by the bar (e.g., in a new window or a pop-up window). The depiction 622 of Plot 1 and the bars 624 may be rotatable or otherwise manipulated via the interface of the client device 108 such that the user can obtain views of the depiction 622 and bars 624 from multiple angles.

The GUIs 600, 608, and 620 should be construed as non-limiting examples. The agricultural management system 102 can include additional tabs, sub-tabs, metrics, and the like. The GUIs 600, 608, and 620 can include one or more interactive elements and/or interactive data visualizations configured to enable a user to view and explore agricultural data associated with the agricultural operation. In some aspects, the GUIs generated by the agricultural management system 102 can include predictions, forecasts, models, and/or projections of future data and metrics.

Accordingly, the agricultural management system 102 can efficiently and dynamically collect and analyze agricultural data from multiple sources, as well as determine and/or execute actionable steps for managing the agricultural operation. The agricultural management system 102 provides users with both fine-tuned and high-level visualization tools to analyze and explore both historic and real-time data. Disclosed systems and methods improve upon existing systems that fail to capture and integrate data from an extensive number of available sources. Further, disclosed systems and methods leverage machine learning techniques to predict future metrics and to automatically monitor the agricultural operation or to automatically manage the agricultural operation (e.g., via devices such as drones and farming equipment).

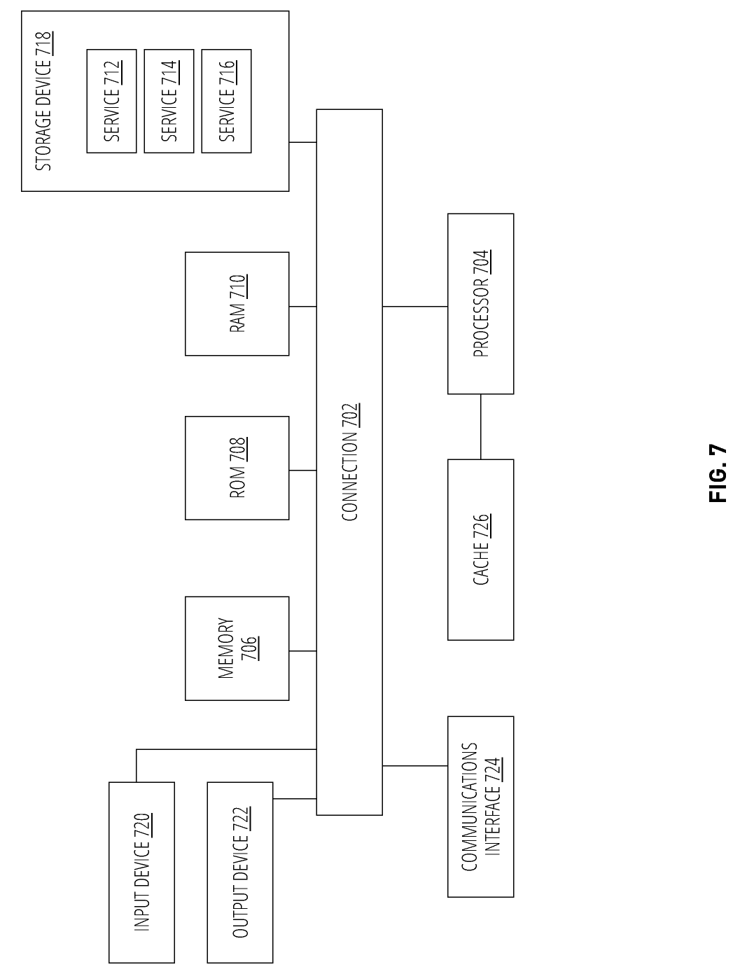

FIG. 7 illustrates a computing system architecture, according to some aspects of the present disclosure. Components of computing system architecture 700 are in electrical communication with each other using a connection 702. Connection 702 can be a physical connection via a bus, or a direct connection into processor 704, such as in a chipset architecture. Connection 702 can also be a virtual connection, networked connection, or logical connection.

In some examples, computing system 700 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 700 includes at least one processing unit (CPU or processor) 704 and connection 702 that couples various system components including system memory 706, such as read-only memory (ROM) 708 and random-access memory (RAM) 710 to the processor 704. Computing system 700 can include a cache 726 of high-speed memory connected directly with, in close proximity to, or integrated as part of processor 704.

Processor 704 can include any general-purpose processor and a hardware service or software service, such as services 712, 714, and 716 stored in storage device 718, configured to control processor 704 as well as a special-purpose processor where software instructions are incorporated into the actual processor design. Processor 704 may essentially be a completely self-contained computing system, containing multiple cores or processors, a bus, memory controller, cache, etc. A multi-core processor may be symmetric or asymmetric.

To enable user interaction, computing system 700 includes an input device 720, which can represent any number of input mechanisms, such as a microphone for speech, a touch-sensitive screen for gesture or graphical input, keyboard, mouse, motion input, speech, etc. Computing system 700 can also include output device 722, which can be one or more of a number of output mechanisms known to those of skill in the art. In some instances, multimodal systems can enable a user to provide multiple types of input/output to communicate with computing system 700. Computing system 700 can include communications interface 724, which can generally govern and manage the user input and system output. There is no restriction on operating on any particular hardware arrangement, and therefore the basic features here may easily be substituted for improved hardware or firmware arrangements as they are developed.

Storage device 718 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 718 can include software services, servers, services, etc., that when the code that defines such software is executed by the processor 704, it causes the system to perform a function. In some examples, a hardware service that performs a particular function can include the software component stored in a computer-readable medium in connection with the necessary hardware components, such as processor 704, connection 702, output device 722, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some examples, a service can be software that resides in memory of a client device and/or one or more servers of a content management system and perform one or more functions when a processor executes the software associated with the service. In some examples, a service is a program or a collection of programs that carry out a specific function. In some examples, a service can be considered a server. The memory can be a non-transitory computer-readable medium.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A computer-implemented method comprising:
accessing, by an agricultural management system, first data from an operational database of the agricultural management system;
accessing, by the agricultural management system, second data from a real-time data server of the agricultural management system;
determining, by the agricultural management system, a metric based on the first data and the second data;
generating a first graphical user interface (GUI) for display on a client device, wherein the first GUI comprises at least one data visualization based on the metric;
adjusting, by the agricultural management system, a setting of a piece of equipment.

2. The computer-implemented method of claim 1, wherein accessing the first data comprises:
accessing raw data from a data source of one or more data sources;
generating, based on the data source, event data, wherein the event data comprises a data source type;
processing the raw data based on the event data, wherein processing the raw data comprises generating structured and standardized data;
determining, based on the event data, a database of a set of databases for storing the structured and standardized data; and
storing, in the database, the structured and standardized data.

3. The computer-implemented method of claim 2, wherein the one or more data sources comprises a ledger stored in a blockchain, wherein the ledger stores user-provided data.

4. The computer-implemented method of claim 1, wherein the second data is sensor data received from one or more sensors that are communicatively coupled to a long-range wide area network gateway configured to receive data from the one or more sensors via long-range wide area network.

5. The computer-implemented method of claim 4, wherein the one or more sensors comprise a tracker coupled to equipment.

6. The computer-implemented method of claim 4, the method further comprising:
generating, by the agricultural management system, a second graphical user interface (GUI), wherein the second GUI is configured for enabling a user to configure or control the one or more sensors.

7. The computer-implemented method of claim 1, wherein the visualization is updated based on changes to the metric resulting from real-time updates to the first data, the second data, or a combination thereof.

8. The computer-implemented method of claim 1, wherein the visualization comprises a comparison of the metric with a regulatory requirement.

9. The computer-implemented method of claim 1, the method further comprising:
applying the first data and the second data to a machine learning model trained on data from the at-rest database and the real-time data server;
receiving, from the machine learning model, a prediction of a future state of a plot associated with the first data and the second data; and
automatically adjusting a setting of the piece of equipment based on a deviation of the future state from a threshold future state.

10. The computer-implemented method of claim 9, the method further comprising:
monitoring, by the agricultural management system, the plot based on real-time data; and
automatically adjusting the setting of the piece of equipment based on a change in the state of the plot.

11. A system for managing agricultural operations, the system comprising:
a processor; and
a non-transitory computer-readable storage medium containing instructions which, when executed on the processor, cause the processor to perform operations comprising:
accessing first data from an operational database;
accessing second data from a real-time data server;
determining a metric based on the first data and the second data;
generating a first graphical user interface (GUI) for display on a client device, wherein the first GUI comprises at least one data visualization based on the metric; and
adjusting a setting of a piece of equipment.

12. The system of claim 11, wherein accessing the first data comprises:
accessing raw data from a data source of one or more data sources;
generating, based on the data source, event data, wherein the event data comprises a data source type;
processing the raw data based on the event data, wherein processing the raw data comprises generating structured and standardized data;
determining, based on the event data, a database of a set of databases for storing the structured and standardized data; and
storing, in the database, the structured and standardized data.

13. The system of claim 12, wherein standardizing the raw data comprises converting the raw data into a common format using a machine data compiler service.

14. The system of claim 11, wherein the second data is sensor data received from one or more sensors that are communicatively coupled to a long-range wide area network gateway configured to receive data from the one or more sensors via long-range wide area network.

15. The system of claim 14, wherein the one or more sensors comprise a tracker coupled to equipment.

16. The system of claim 14, wherein the operations further comprise:
generating a second graphical user interface (GUI), wherein the second GUI is configured for enabling a user to configure or control the one or more sensors.

17. The system of claim 11, wherein the visualization is updated based on changes to the metric resulting from real-time updates to the first data, the second data, or a combination thereof.

18. The system of claim 11, wherein the operations further comprise:
accessing third data from a third-party system via a third-party application programming interface (API); and
determining the metric based, at least in part, on the third data.

19. The system of claim 11, wherein the operations further comprise:
applying the first data and the second data to a machine learning model trained on data from the at-rest database and the real-time data server;
receiving, from the machine learning model, a prediction of a future state of a plot associated with the first data and the second data; and
automatically adjusting a setting of the piece of equipment based on a deviation of the future state from a threshold future state.

20. The system of claim 19, wherein the operations further comprise:
monitoring the plot based on real-time data; and
automatically adjusting the setting of the piece of equipment based on a change in the state of the plot.
